(19) United States
(12) Patent Application Publication
(10) Pub. No.: US 2026/0261784 A1
(43) Pub. Date: Sep. 3, 2026

(54) TELEMATICS DEVICE AND FRAME

(71) Applicants: Steve TEW, Garsington, Oxford (GB); Benjamin COULL, Garsington, Oxford (GB); Solar Telematics Ltd, Garsington, Oxford (GB)

(72) Inventors: Steve TEW, Garsington (GB); Benjamin COULL, Garsington (GB)

(73) Assignee: Solar Telematics Ltd, Garsington, Oxford (GB)

(21) Appl. No.: 19/489,493

(22) PCT Filed: Jun. 12, 2024
(86) PCT No.: PCT/EP2024/066273

§ 371 Date: Dec. 2, 2025

(30) Foreign Application Priority Data
Jun. 13, 2023 (GB) 2308849.5
Nov. 13, 2023 (GB) 2317384.2

(51) Int. Cl. H04Q 9/00

(52) U.S. Cl. CPC H04Q 9/00; H04Q 2209/886

(57) ABSTRACT

The telematics device includes a press button release lock mechanism to allow removal from its cradle and allow possible remote power charging, and a method of notification if the telematics device is removed from the cradle and placed back in the cradle, including a method to disable certain features in the telematics device firmware to conserve power and indicate a tamper alert during removal. Further described is a frame suitable for holding a telematics device that is designed to be attached to a vehicle window, and allow part or parts of the frame to deform away in the event that force is used to take the frame away from the window, which then causes the telematics solar cell to open and create a tamper alert, and send the tamper alert to the insurance company via the mobile network.

### TECHNICAL FIELD

The present invention relates to telematics units and corresponding frames to facilitate the instalment of telematics units to vehicles. The present invention further relates to a tamper alert for a telematics unit.

### BACKGROUND

Telematics systems have been in use for a number of years and their installation into all types of vehicles is vast. A telematics device is generally a system that is installed in a vehicle that records information about the driver driving habits, such as geographical location, the number of miles driven, driving speed, and how quickly the vehicle brakes, how fast corners are taken.

When buying vehicle insurance, the insurance is based on the vehicle and driver, their age, experience, the type of vehicle driven and value, geographical location and driving style. A telematics system helps with personalised insurance, which is based on the speed, braking, cornering, distance travelled and time of day travelled, that the insured driver does when driving, which helps indicate to the insurance company assess risk, and how well the driver performs, this can increase or reduce insurance premiums for the driver. It's important that the telematics device, used for insuring the driver, stays attached to the insured vehicle and the telematics device is operational at all times that the insured driver drives, and removal of said telematics device for whatever reason is notified to the insurance company; the insurer will then act upon that information received accordingly.

Telematics insurance is a type of insurance that typically involves fitting and removing an electronic monitoring telematics device to a vehicle by a technician. A problem with current telematics devices is they need to be professionally installed and wired into the vehicles electrical system; this can sometimes invalidate the manufacturer's warranty on the vehicle, also, the telematics device if connected to the vehicle electrical system can drain the battery as it's always connected, also there is additional cost in employing a technician to install and remove the telematics device at the beginning and the end of the insurance period, causing telematics devices to really only cater for the high premium demographic drivers, usually young drivers where the high cost of installation, removal and the telematics unit cost can be absorbed via their insurance premium.

Two issues are considered here

### (1) Release Mechanism

New telematics devices are non-invasive and some use battery technology and periodic times to charge their batteries, thus not relying on the car electrical system, the advantage being that the device can be installed by the customer and not a technician, saving cost. For example, a solar charged telematics device would need to be attached to the windscreen of the vehicle or dashboard, or another window in the vehicle. This means the telematics device would be installed by the customer on the vehicle windscreen via a frame with pads to hold and secure the telematics device in place on the windscreen.

### (2) Tamper Alert

Telematics insurance is personalised insurance, thus, it's very important the telematics device is only used for the driver who's insured and on that insured person's vehicle, as the cost of subsidised insurance is based on the insured person's driving behaviour and driving the insured vehicle. It is a requirement of the telematics insurance that if the telematics' device is installed in the insured person's vehicle, and the telematics device is tampered with or removed, an automatic notification via the mobile network is sent to the insurance company to notify possible fraudulent use, for example being removed and installed on another vehicle driven by a better driver to keep insurance premiums low.

### SUMMARY

### (1) Release Mechanism

According to a first aspect of the present invention, there is provided a telematics unit with a fitted press release button and cradle, the telematics unit via the cradle is attached to the vehicle windscreen via adhesive pads, fitting the telematics unit this way compensates for the curvature of the windscreen, thus when the telematics unit is removed from the cradle, it's easy for the telematics unit to re-seat back into the cradle.

A vehicle telematics unit attachable to the interior of a vehicular windscreen of a vehicle via a corresponding mounting cradle, wherein the mounting cradle is lockable to said telematics unit and attachable to said vehicular windscreen, wherein the telematics unit is releasable from the cradle by pressing a button on the telematics unit to a locked down pressed state position to unlock it from the cradle, and wherein the telematics unit is configured such that pressing of the button to the locked down pressed state position causes the telematics unit to send a notification to a remote data server.

Optionally, in the event that the telematics unit is placed back in its cradle after being removed from the cradle, the telematics unit is configured such that the push button returns to its original upright position to cause the telematics unit to send a second notification to the remote data server.

Optionally, the telematics unit further comprises a mechanical electrical push switch and an electrical circuit; wherein the telematics unit is configured such that pressing of the button to the locked down pressed state position causes the mechanical electrical push switch to change from a first state to a second state, and wherein the notification is sent by the electrical circuit and is indicative of the electrical push switch in the second state.

Optionally, the electrical push switch is further configured to change from the second state to the first state upon return of the push button returns to its original upright position, and wherein the second notification is sent by the electronic circuit and is indicative of the electrical push switch in the first state.

Optionally, the telematics unit is further configured to monitor XYZ axis data obtained from an accelerometer and/or gyroscope of the telematics device, and wherein the telematics device is further configured, upon detection of a change in the XYZ axis data, to check the state of the mechanical electrical push switch and notify the remote data if the mechanical electrical push switch is in the first state.

Optionally, notification to the remote data server of the mechanical electrical push switch being in the first state is indicative of tampering of the telematics unit.

Optionally, the telematics unit further comprises a calibration module configured to record an original state of the calibration data as XYZ axis data obtained from an accelerometer and/or gyroscope of the telematics device when the telematics device is locked to the cradle, and wherein the calibration module is further configured, subsequent to the relocking of the telematics device to the cradle following unlocking from the cradle via the push button, to record any discrepancy in the current XYZ axis data compared to the original XYZ axis data and to send a notification of any discrepancy to a remote data server.

Optionally, the telematics unit is configured to disable the calibration module in response to a change of the mechanical electrical push switch from the first state to the second state, and wherein the telematics unit is further configured to reactivate the calibration module following a change in the mechanical electrical push switch from the second state to the first state.

Optionally, the telematics unit is configured such that the button remains in the locked down pressed state position whilst the telematics unit is removed from the cradle.

Optionally, the telematics unit further comprises a press button part, wherein the telematics unit is configured such that pressing the button to the locked down pressed state position displaces the press button part to press the mechanical electrical switch to cause the mechanical electrical switch to change its state.

Optionally, the telematics unit is configured such that pushing of the button to the locked down pressed position releases a pair of springs disposed in the telematics unit to displace a locking section of the telematics unit towards the cradle to push the telematics unit away from the cradle to release it from the cradle.

Optionally, the springs are part of a telematics locking mechanism of the telematics unit, wherein the telematics locking mechanism consists of a plurality of non-metallic mechanical parts that interlock with each other, to allow the release of the locked telematics unit.

Optionally, the telematics unit further comprises a solar cell configured to charge telematics unit.

Optionally, in the event that the telematics unit is removed from its cradle via the push button, the telematics unit is further configured to disable a firmware feature in the current telematics unit that normally records a journey.

Optionally, in the event that the telematics unit is placed back in its cradle after being removed from the cradle, the telematics unit is configured such that the push button returns to its original upright state to lock the telematics unit to the cradle and resume normal telematics operation.

According to a second aspect there is provided a mounting cradle lockable to the telematics unit of any preceding claim and attachable to a vehicular windscreen of a vehicle.

According to a third aspect there is provided a method of attaching the cradle to the vehicular windscreen using an adhesive gasket.

According to a fourth aspect there is provided a method of attaching the vehicular windscreen using an adhesive pad or plurality of adhesive pads.

Optionally, the gasket is configured to prevent ingress of condensation to the telematics unit.

According to a fifth aspect there is provided a system comprising the telematics unit and cradle.

The mechanical press button array, consists of a plurality of parts that interlock with each other, to allow the release of the locked telematics unit, this is due to the transmit/receive antenna inside the telematics unit is best positioned at the top of the telematics unit for good quality signal purposes and the antenna for telematic units are typically long due to the transmission frequency wave length, thus the antenna will be very near the push button mechanism parts, so only non-metallic parts are used for the mechanics of the switch locking mechanism, as metal would attenuate the radio frequency transmission and reception signal. Later described in detail, that lock in place when removed from the cradle, and the telematics button can only be unlocked/released when placed back onto the cradle.

The release button mechanism when pressed and locked, presses a mechanical electrical switch that informs the telematics unit to informs the insurance company the mechanical electrical switch is pressed.

The mechanical electrical button stays pressed as long as the telematics button is pressed and locked down. The mechanical electrical button changes state as long as the telematics button is released/unlocked.

The release button mechanism when placed back in the cradle, and button unlocked, releases the mechanical electrical switch that informs the telematics unit to inform the insurance company via a remote data server that the mechanical electrical switch is released and the telematics unit is back in the cradle.

When a telematics device is attached to the vehicular, the telematics circuit board will switch on, via a switch. The telematics device will register to the remote data server its details to inform the insurance company that it has been activated so insurance can begin.

A single photograph of the telematics device that is attached to the insured vehicular that includes the registration plate of insured vehicular number plate is taken and sent to the insurance company via a mobile device.

The current invention comprises a mechanically operated electronic switch that operates in two states, on or off, the state of the mechanically operated electronic switch is linked to the state of the calibration module arranged to detect changes in XYZ axis changes, if the calibration module state changes and dependent on the state of the mechanically operated electronic switch, the mechanically operated electronic switch will report to a remote data server this change in state including possible tamper.

Citing patent Application EP(GB)2867867 and noting sections 0027, 0033, 0044, 0050 and claim 15, are different to the current invention of the release and locking mechanism for the proposed telematics device.

Noting patent Application US2005128062A1 and citing sections 0053 to 0057 are different to the current invention, where a Hall effect magnetic switch or reed switch are used to indicate the removal of the phone from the cradle for the purpose of the phone being in the vehicle, or causing a false indication of an accident, we are not indicating if the telematics unit is in the vehicle or not, or of a false accident, we are indicating only that the telematics unit is removed from the cradle for the purpose of power charging or not, noting the charging request to the insured driver is due to the insurance company messaging the insured driver that the battery charge is low on their telematics device and that the driver needs to charge the telematics unit.

### (2) Tamper Alert

According to a sixth aspect there is provided a telematics frame for a telematics device, wherein the telematics frame is attachable to a vehicle window or dashboard, the telematics frame comprising deform points, which, in use, with the frame attached to the vehicle window or dashboard and the telematics device inserted in the frame, are configured to deform in shape when a force is applied to remove the telematics device from the vehicle window or dashboard to trigger a tamper switch of the telematics device.

Optionally, the telematics frame is attachable to the vehicle window or dashboard with an adhesive.

Optionally, the telematics device is solar charged and the tamper switch is a solar cell of the telematics device.

According to a seventh aspect there is provided a telematics device which, when fit to the frame, with the frame attached to the window or dashboard, is configured such that when a force is used to remove the telematics device from the window, the solar cell of the telematics device opens.

According to an eighth aspect there is provided a telematics device, which, when fit to the frame, is configured such that upon deformation of the frame, at least part of the solar cell moves away from the telematics device towards the telematics frame to open an electrical circuit of the telematics device.

Optionally, the telematics device is configured to send a tamper alert if the tamper switch is triggered.

Optionally, the data related to the tamper alert is sent via radio frequency (RF) transmission.

According to a ninth aspect there is provided a solar telematics unit comprising the telematics frame and the telematics device.

It's important that the telematics device is attached to the vehicle windscreen/window or dashboard (this allows sunlight to fall on the telematics device solar cell and charge the plurality of batteries) and is secured in place, thus in the event of an accident, the telematics device does not come away easily from the windscreen. It's also important for insurance purposes, that once the telematics device is installed, that if removed from the windscreen by tampering that it activates a tamper switch. The tamper alert is sent to the insurance company to notify them the telematics device has been tampered with.

### BRIEF DESCRIPTION OF THE DRAWINGS

### (1) Release Mechanism

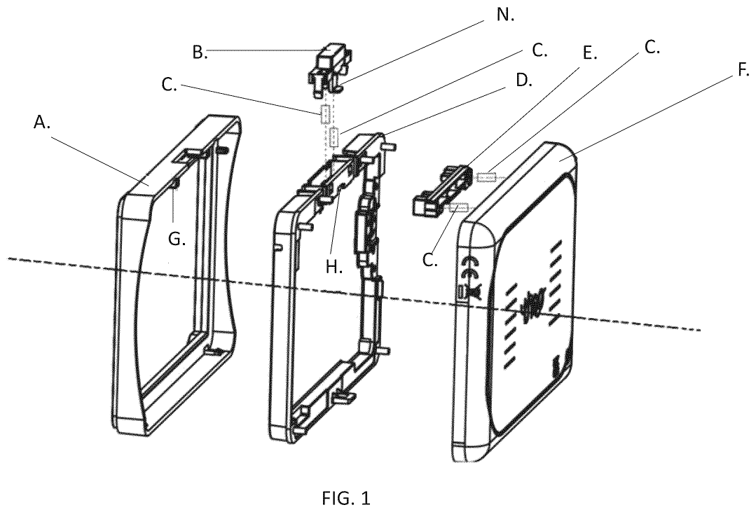

FIG. 1 illustrates according to a release mechanism embodiment:
A. Cradle
B. Push button
C. Spring compression and release tubes
D. Inner frame, houses the push button and retains it in place to allow the push button to move up and down
E. Moving locking section, that moves backwards and forwards
F. Front cover
G. Cradle with extruding rods×2
H. This section houses the push button and retains it in place to allow it to move and down
N. Part that presses down on the mechanical electrical switch to change the mechanical electrical switch state

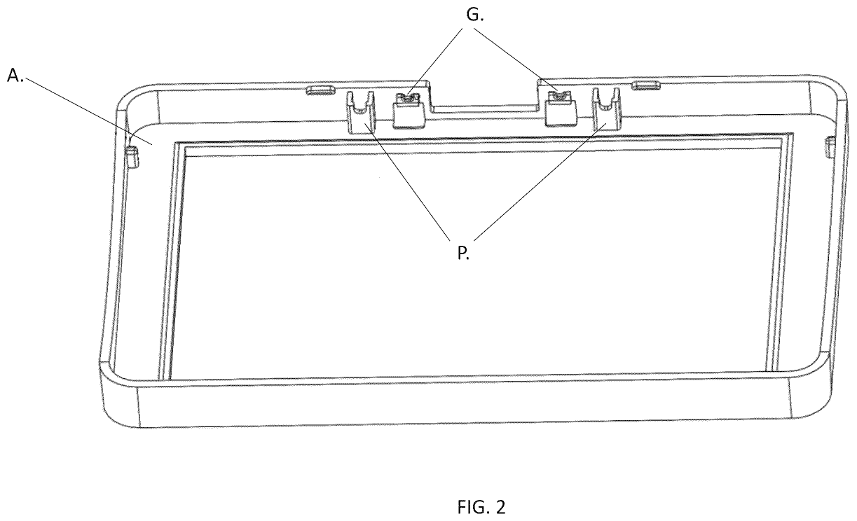

FIG. 2 illustrates according to a release mechanism embodiment:
A. Cradle
G. Locking section related to the push button
P. Cradle extruded rods

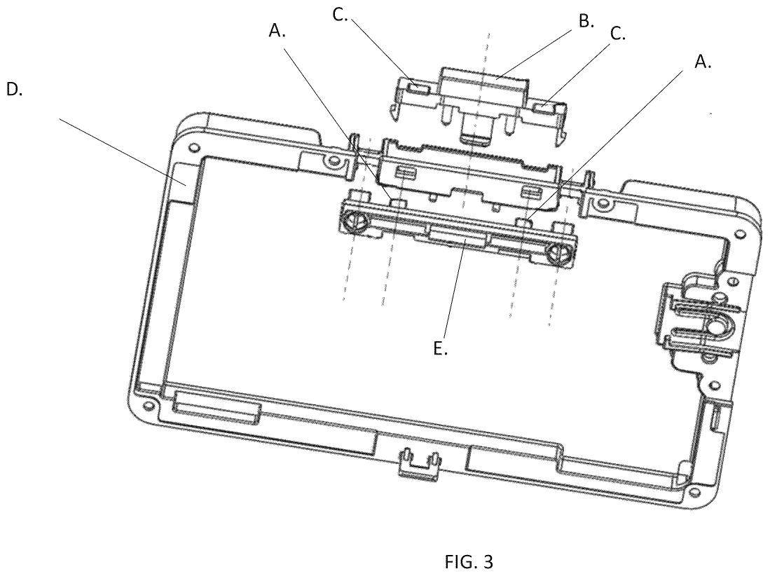

FIG. 3 illustrates according to a release mechanism embodiment:
A Protruding section, this part moves backward and forward only, when forward it locks the push button down, when moved backward it releases the push button. It's pushed backward by cradle rods when cradle is fitted
B. Push button with two slots (C)
C. Slots×2 for receiving 2×protruding parts in A above
D. Inner frame, houses the push button and retains it in place to allow the push button to move up and down
E. Part that moves back and forward only using rubber tubes as springs
It's pushed back by the 2×cradle rods when the cradle is fitted.

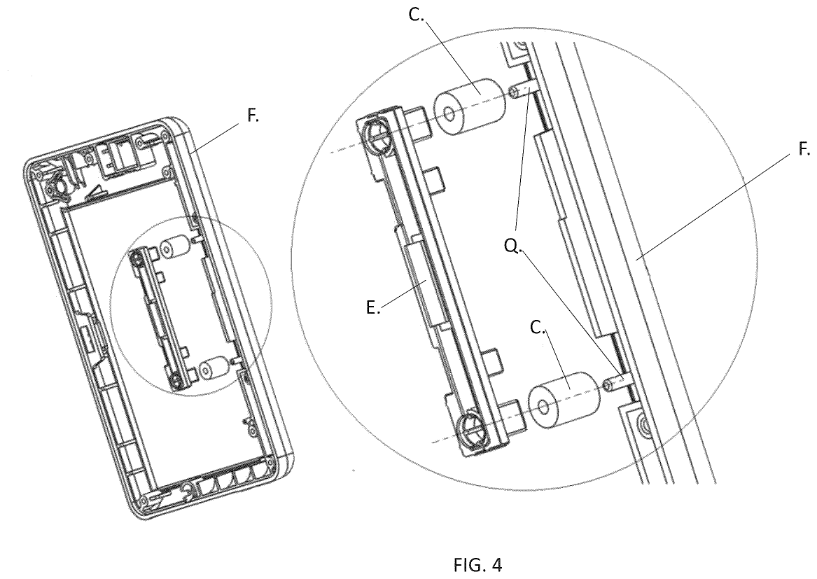

FIG. 4 Illustrates According to a Release Mechanism Embodiment:
F. Front cover
C. Spring compression and release tubes
E. Part that moves back and forward using spring tubes as springs.
Q. Extrudes that hold the Spring compression and release tubes on front cover (F)

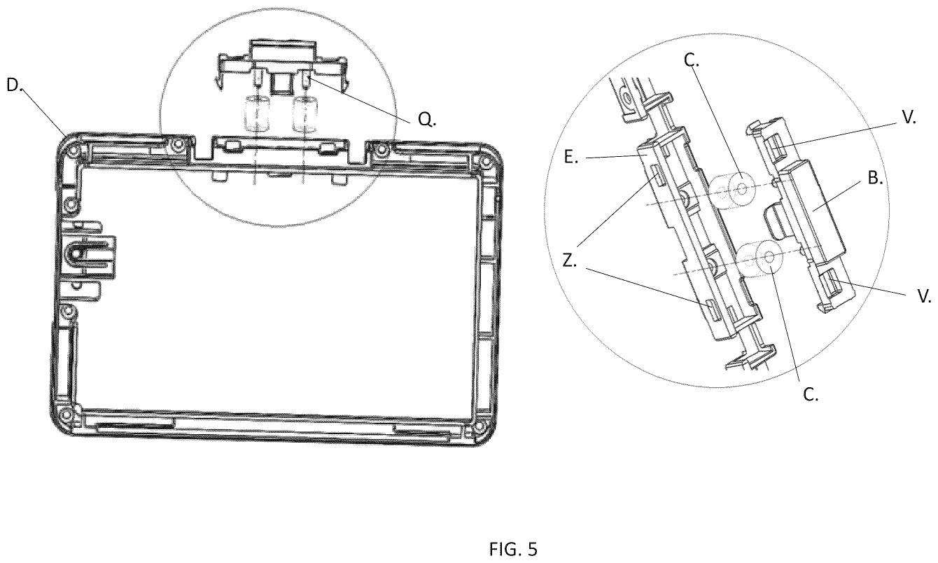

FIG. 5 illustrates according to a release mechanism embodiment:
B. Push button
C. Spring compression and release tubes
D. Inner frame, houses the push button and retains it in place to allow the push button to move up and down
E. Part that moves back and forward only spring tubes as springs
It's pushed back by the 2×cradle rods when the cradle is fitted.
Q. Round extrudes on push button that hold the Spring compression and release tubes in place
V. Recess for receiving protrudes to lock button in place when pressed down and front cover is pulled away from the cradle
Z. Slots where protrudes go through to lock down push button when push button is pressed down and front cover is pulled away from the cradle

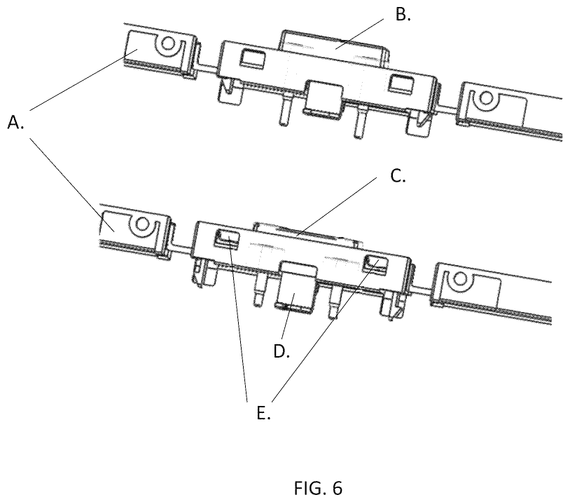

FIG. 6 illustrates according to a release mechanism embodiment:
A. Inner frame, houses the push button and retains it in place to allow the push button to move up and down
B. Push button
C. Push button in push down position
D. Part that presses down on the mechanical electrical switch to change the mechanical electrical switch state
E. Fully open section to allow locking rods in when telematics unit is removed from cradle

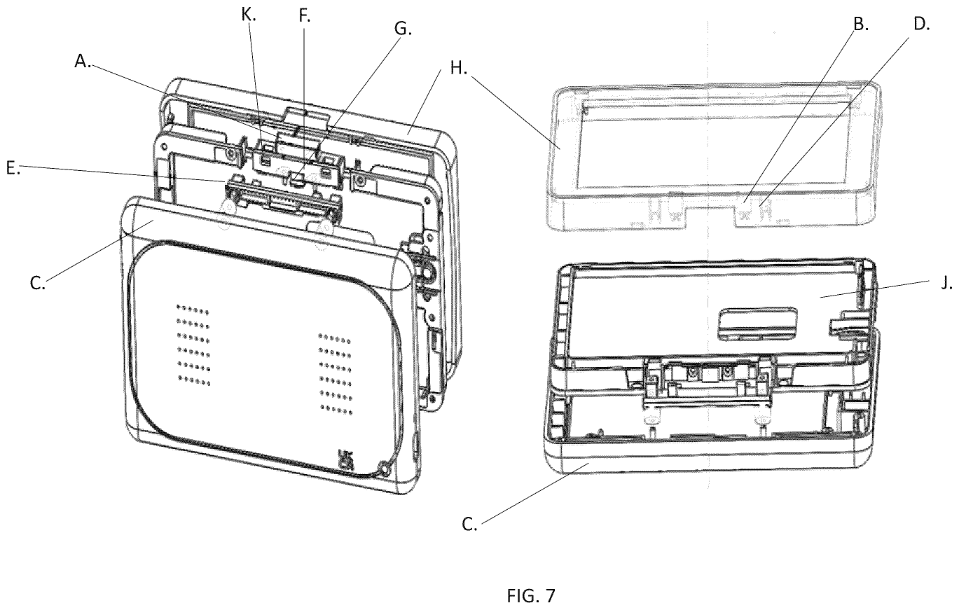

FIG. 7 illustrates according to a release mechanism embodiment:
A. Push button
B. Cradle With Extruding Rods×2
C. Front cover
D. Locking section in cradle related to push button locking section
E. Moving locking section, that moves backwards and forwards
F. Inner frame, houses the push button and retains it in place to allow the push button to move up and down
G. Part that presses down on the mechanical electrical switch to change the mechanical electrical switch state
H. Cradle
J. Inner frame, houses the push button and retains it in place to allow the push button to move up and down
K. Button Locking section related to the cradle locking section D.

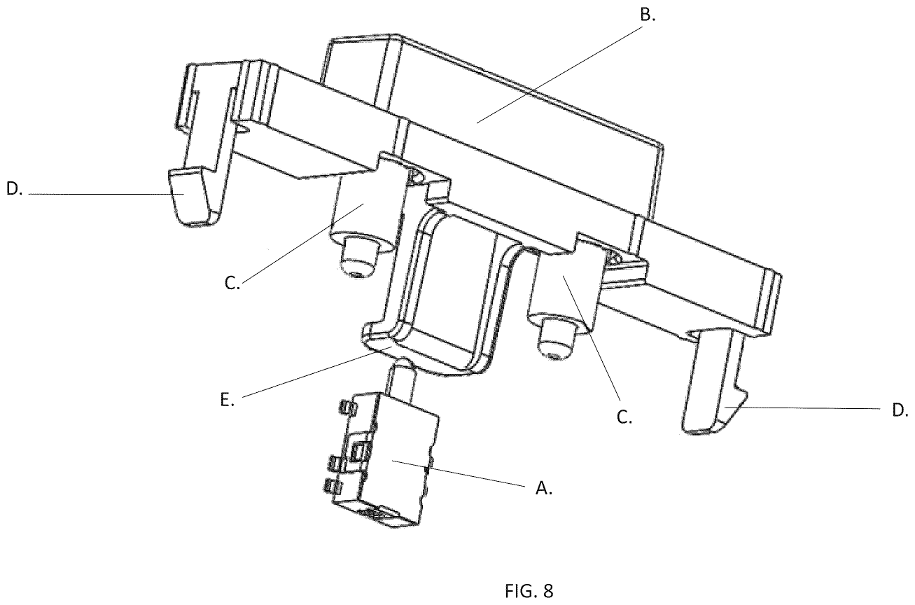

FIG. 8 illustrates according to a release mechanism embodiment:
A. The mechanical electrical switch that can change state when pressed or released
B Push button
C. Spring compression and release tubes
D. Part that presses down in the inner housing, and houses and retains itself via the hooked section on the sides, to stop it falling out of the Inner frame, houses the push button and retains it in place to allow it to move and down
E. Part that presses down on the mechanical electrical switch to change the mechanical electrical switch state.

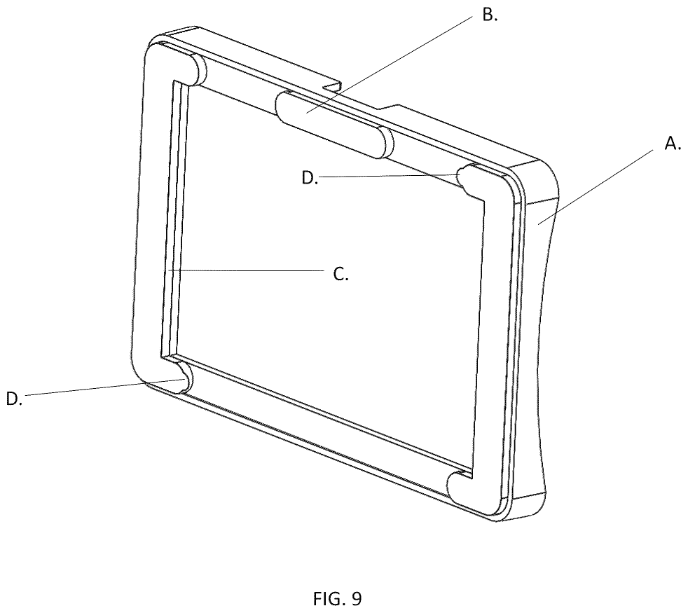

FIG. 9 illustrates a support pad for the cradle frame according to a release mechanism embodiment:
A. The frame
B. The support pad adhered to the frame
C. Adhesive pads that adhere the telematics frame to the windscreen.
D. Adhesive pull off film, to expose adhesive pad(s).

### (2) Tamper Alert

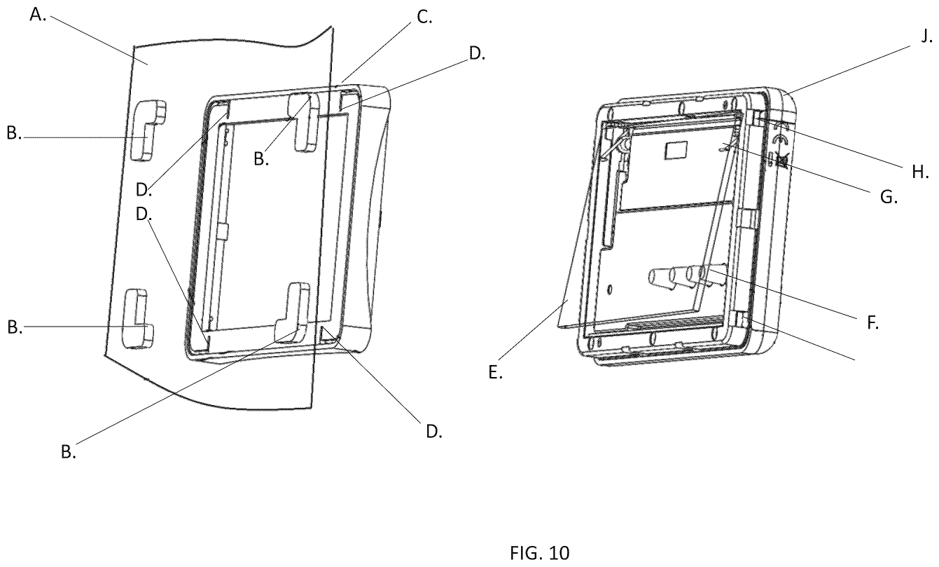

FIG. 10 illustrates according to a tamper alert embodiment:
A. Glass
B. Pad
C. Frame
D. Deform point
E. Solar Cell
F. Spring
G. Solar panel spring
H. Locking section
J. Telematics device

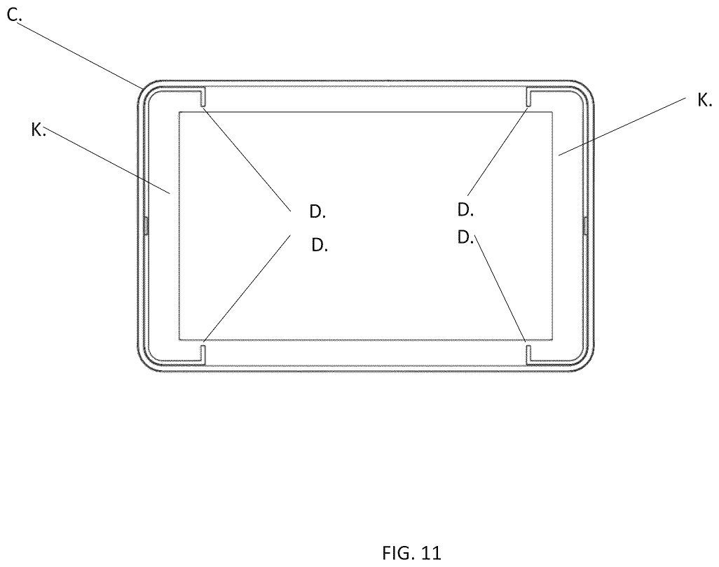

FIG. 11 illustrates according to a tamper alert embodiment:
C. Frame
D. Deform point
K. Deform section

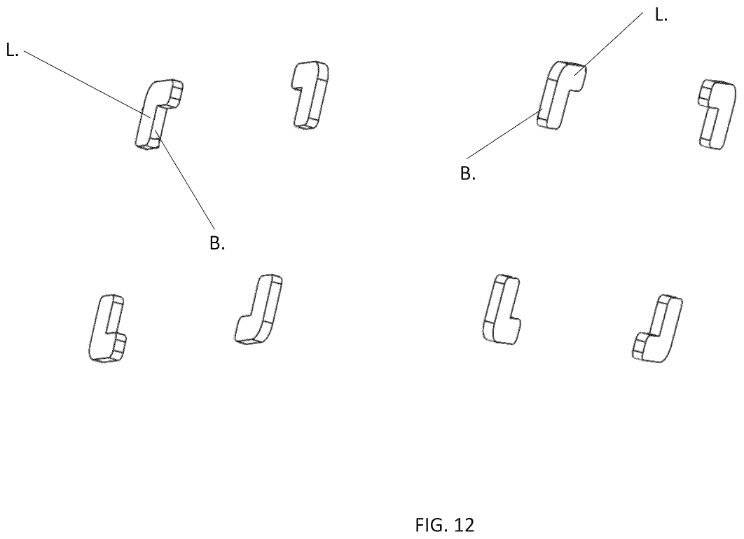

FIG. 12 illustrates according to a tamper alert embodiment:
B. Pad
L. Adhesive on pad to glass

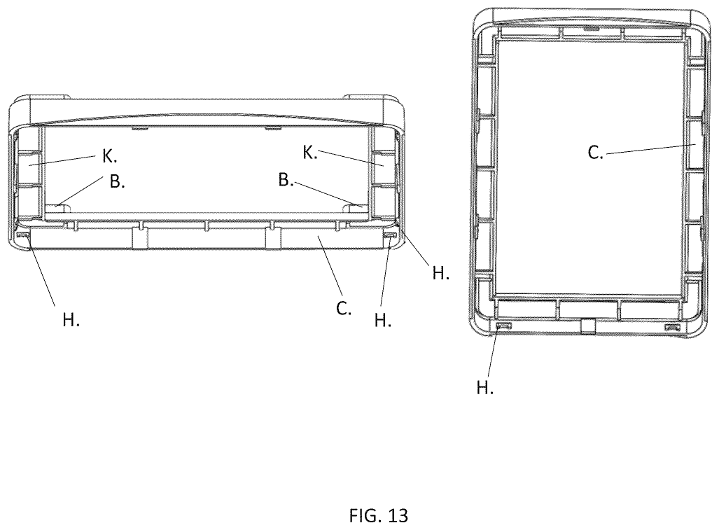

FIG. 13 illustrates according to a tamper alert embodiment:
B. Pad
C. Frame
H. Locking section
K. Deform section

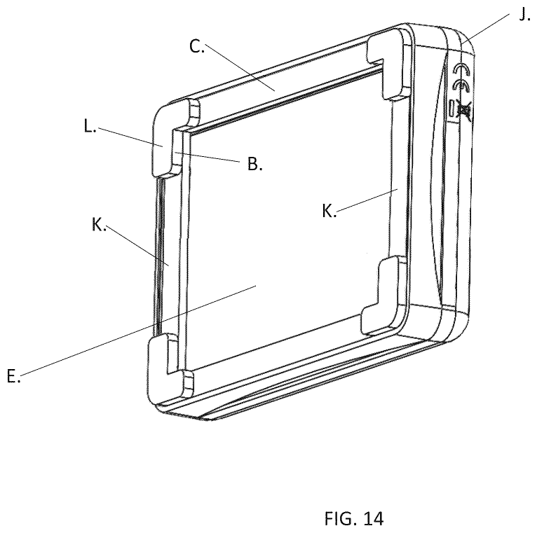

FIG. 14 illustrates according to a tamper alert embodiment:
B. Pad
C. Frame
E. Solar Cell
J. Telematics device
K. Deform section
L. Adhesive on pad to glass

### DETAILED DESCRIPTION

The following description comprises a first section relating to a release mechanism aspect, followed by a second section relating to a tamper alarm aspect. Although presented as distinct concepts it will be appreciated that features of the concepts may be selected and combined to provide a novel system.

### Release Mechanism

Embodiments relate to a solar charged battery powered telematics device with a corresponding mounting cradle, the cradle is attached to the interior of a vehicular windscreen via adhesive pad or plurality of adhesive pads on the telematics cradle, in a second embodiment of the current invention, a gasket can be used to attach the cradle to the windscreen, to create a uniform adhesive barrier on the cradle, to prevent ingress from condensation and other foreign parts to the telematics unit. The cradle seats a telematics device and then the cradle is then attached to the vehicular windscreen, a press release non sliding button on the telematics unit is pressed that allows the telematics device to be removed from the cradle, this allows the telematics unit to be removed physically from the cradle and taken to a place and allow electrical charging of the telematics battery via the charging port in the telematics device using a power charger, in one example, the place can in the home, another example the office, as it's easier to charge overnight and not dependant or depleting the vehicle battery, another example is using a portable charger to charge the telematics unit, or in a further example, leaving the telematics unit in direct sunlight to charge the battery via the solar cell. In addition, the telematics has an accelerometer with gyroscope built-in, when the telematics unit with cradle are first attached to the vehicle windscreen, the XYZ axis data measured in gravitational force from the accelerometer with gyroscope will differ from windscreen to windscreen due to the angle and curvature of the windscreen, the angle of the device when fitted will change with each different vehicle position and make of vehicle model, this will impact the results of the XYZ axis data, the telematics once fitted and activated and calibrated on the windscreen will have XYZ axis values.

### EXAMPLE 1

BMW™ Series 4. Telematic axis values attached to windscreen, stationary vehicle
X 0.236G
Y −0.237G
Z 0.231G

### EXAMPLE 2

Same Telematics axis values removed from Windscreen and on floor for example
X 0.020G
Y 0.00G
Z 1.00G

### EXAMPLE 3

BMW™ Series 4. Telematics axis values attached BACK onto windscreen, stationary vehicle
X 0.236G
Y −0.237G
Z 0.231G

The proposed embodiment comprises a mechanically operated electronic switch that operates in two states, on or off, the state of the mechanically operated electronic switch is linked to the state of the calibration module arranged to detect changes in XYZ axis changes, if the calibration module state changes and dependent on the state of the mechanically operated electronic switch, the mechanically operated electronic switch will report to a remote data server this change in state

To remove the telematics unit from its cradle requires physical means to remove, a convenient way to remove the telematics unit from the cradle is to use a release mechanism. The proposed release mechanism is a mechanical press button consisting of numerous parts that work together to release the telematics unit from the cradle and one of those parts in the telematics unit physically presses a mechanical electrical switch.

When the telematics unit is placed back onto the cradle, the mechanism releases the press button and in so, changes the mechanical electrical switch state.

The push button location is placed at the top of the telematics unit, as this allows easy access to press for the insured driver. If the telematics unit is fitted too low down, or too much to the side, it may not be accessible for the driver to press the switch. Noting it'll be impractical to place the unit too high up, as a power charging wire would lead from the charging socket to the telematics unit going across the windscreen and obscuring the driver's view.

The antenna inside the telematics unit is best positioned at the top of the telematics unit for good quality signal purposes and the antenna for telematic units are typically physically long due to the transmission frequency wave length, thus the antenna will be very near the push button mechanism parts, so only non-metallic parts are used for the mechanics of the switch mechanism, as metal would attenuate the radio frequency transmission and reception signal.

When the telematics button is pressed physically down, the mechanical operation is such that the button stays in the locked down pressed state position until the telematics unit is placed back in the cradle, the pressed button, when in the pressed state, also operates a mechanical electrical on/off switch, the switch is connected to the electronics inside the telematics unit, which in turn sends a notification to a remote data server to notify that the telematics unit is removed from its cradle, and conversely when the telematics unit is placed back in its cradle, the telematics button mechanism will physically release the locked in position button to its original state and also the mechanical electrical switch will change state and send a notification to a remote data server to notify that the telematics unit is placed back in its cradle. This is important from an insurance company perspective, that the insurance company are notified the telematics unit is not in the cradle and is being charged, due to the vehicle driver will be uninsured if the vehicle is driven without the telematics unit attached to the insured persons vehicle and also that the telematics unit as a condition of insurance is sufficiently charged to do its designed purpose, the operation of the mechanical electrical switch is linked with calibration component in the telematics unit.

If the telematics unit button is pressed, and the telematics unit removed from its cradle, Example 1. Axis data would change in values. The change in axis data values in conjunction with the physical button pressing the mechanical electrical switch via the locking mechanism, would indicate at remote data server level the telematics unit has been removed from its cradle.

If the telematics unit is placed back onto its cradle at any time, the telematics button is then unlocked, and the and the telematics button and mechanical electrical switch both return to their original state. This then allows Example 1. Axis data values to match Example 3. Axis data values again.

The change in axis data values in conjunction with the physical button/mechanical electrical switch released via the locking mechanism, would indicate at remote data server the telematics unit has been placed back in its cradle.

The telematics unit also has a firmware function in the telematics firmware. If 0.3G is exerted on any XYZ axis at any time, the telematics unit will activate recording a vehicle journey, the journey data which is Global Navigation Satellite (GPS) data, accelerometer data and gyroscopic data and knots is recorded to the telematics unit memory for transmission to remote data server.

The telematics unit is activated due to 0.3G or more exerted on any XYZ axis and the telematics unit starts to record in memory a journey, the journey data which is GPS data, accelerometer data and gyroscopic data and knots is recorded, but if the XYZ axis force is above 0.3G but does not change after activation by a small value example 2% on any axis, but value can be changed, the telematics device will operate for 60 minutes, then recalibrate to its current position and sleep, this will then become the new Example 1 axis values. This feature is designed to allow an insured customer to move the cradle to another vehicle/position, but this change would be sent to the remote data server.

Pressing the telematics release button, which then locks the button and mechanical electrical switch in place when removed from the cradle, would be disable this activation and calibration feature, to stop false recordings, false activation and save power.

The present telematics device is solar charged, but may require external charging due to external conditions, for example, the vehicle parked in an area with low sunlight, or a vehicle driven a high mileage thus using more power.

A detailed description for the locking mechanism for the telematics device is given below using FIG. 7.

The telematic unit consists of two main assemblies.

The Telematics main unit is a complete unit assembly, the Cradle is a single piece

Telematics main unit:
1. The Front Cover C, is attached to Inner Frame J
2. Push Button A, is push fitted into the Inner Frame J
3. Push Button A can move freely up and down as it has Spring compression and release tubes that in their normal state are expanded, so the Push Button A is in the up position.
4. The Moving Locking Section E, fits between the Front Cover C and the Inner Frame J
5. Moving Locking Section E, can move freely back and forward as it has Spring compression and release tubes that in their normal state they are compressed, due to the Cradle extrudes B pushing Moving Locking Section E back.

Cradle:
1. The Cradle H Consists
   a. 2×Extrudes B
   b. 2×Locking Section D

### Removing the Telematics Unit from the Cradle

If Push button FIG. 7A is not in the pressed state, the telematics unit and cradle stay locked together, this is because Push button locking section FIG. 7K is locked onto the cradle FIG. 7D locking section.

To release the telematics unit from the cradle, pressing the push button and pulling the telematics unit away from the cradle.

Pressing the Push button A which is held in the upright position by FIG. 7B extrudes, and pulling the telematics unit away from the cradle H, this is now allowing the Push Button locking section FIG. 7K which is locked onto the cradle FIG. 7D locking section to be released and FIG. 7D to leave section FIG. 7K, also in doing so, it allows the Moving Locking Section E to move forward into section FIG. 7K, under the pressure from the two Spring compression and release tubes.

When Button A is pressed down and the telematics unit is released the from the Cradle H, and the telematics pulled away from the Cradle H, as the two Cradle H extrudes B move away from the telematics unit, this now allows the two Cradle H extrudes B to be removed from the telematics unit, this in turn allows Moving Locking Section E to move forward, when moving forward, the Locking Section E now locks the Push Button A in the locked down position

When Push Button A in the down position, a portion of Push Button A presses the mechanical electrical switch, and forces the mechanical electrical switch to change state.

### Placing the Telematics Unit Into the Cradle

Placing the telematics unit back onto the Cradle H, allows the two Cradle H extrudes B To push the Moving Locking Section E back to its original compressed position. This releases Button A, to go back to its uncompressed original state, this does three things.
1. Allows Button A to pop up so it can be pressed again at any time.
2. Push Button locking section K to lock onto the Cradle D locking section.
3. Push Button A in now in the up position, a portion of Push Button A stops pressing the mechanical electrical switch down, and allows the mechanical electrical switch to change state

### Support for the Cradle

In some embodiments, a foam support can be provided on the cradle. Turing to FIG. 9, the cradle C with a foam support pad B is illustrated. The support pad is adhered to the cradle only, it is not adhered to the windscreen. The support pad supports the frame from deform which could be caused by the “extrudes” on the other side of the frame “pushing” the release mechanism in the telematics unit inwards, the force when pushing telematics unit into the frame.

### Tamper Alarm

The telematics device consists of an electronic monitoring circuit board, which has a GPS System for geographical tracking and a 3-axis accelerometer, this is used for measuring and recording changes in the XYZ axis whilst the vehicle is moving or being driven.

The telematics device has a solar cell fitted on a hinge. The hinge allows the solar cell to swing on an axis. The hinge has a spring that constantly puts force on the solar cell to open.

The solar cell is fitted with electrical contacts, if the solar cell is initially closed previously with an insulated pull out tag between the electrical contact pads on the solar cell and contacts in the telematics unit springs, no contact is made between it and the circuit board contacts springs, so the telematics device is not activated and working. This allows the manufacturer to build the devices and then they can be sent the inactivated telematics device to a customer.

When the telematics device is fitted with the frame, and the solar cell into a closed position, pulling out the insulated tag between the springs and the solar cell will then cause the telematics device to activate and start working.

The proposed frame is designed to allow the telematics device to lock into the frame and force the solar cell to close and electrically activate when the insulated tag is removed.

With reference to FIG. 9, the frame (C.) structure is designed to have adhesive pads (B.) adhered to a deform section (K.) that has a deform points section (D.). The deform points are weakened points that are not mechanically strong and will deform if a strong pulling force is applied to the deform (K.).

The adhesive pads (B.) sit between the deform section (K.) and are adhered onto the vehicle windscreen. If a pulling force is then applied to the frame C. The frame (C.) will deform in shape from the windscreen due to the force and the deform section (K.) will remain on the pads (B.) and on the telematics devices fame and on the windscreen.

The frame design has locking sections (H.) This allows a telematic device assembly to be inserted into the frame and be locked in place. The frame with telematics device is attached to the vehicle windscreen via the adhesive pads, pulling on the telematics device will pull the frame away from the windscreen and will deform in shape behind on the windscreen.

The deform section when in place is designed to keep the solar cell in a closed position. The deform section when not in place is designed to keep the solar cell in an open position. Thus, pulling the telematics device when in the frame, will cause the deform point to deform and the deform sections to change in shape and the solar cell will open circuit.

If the telematics device detects the solar cell is opened after it has been activated, the telematics device will go into tamper mode alert and send a message via the mobile network to the insurance company.

The telematics units described herein in relation to release mechanism aspect and the tamper alert aspect can be powered by an “ultracapacitor”. This is a unique type of capacitor due to the structure. It allows the telematics unit to work effectively in vehicles at very high and extreme low temperatures. A vehicle temperature can reach >100° C. By contrast, rechargeable lithium batteries cannot operate above +85° or −15° C. (without a heater). The “ultracapacitor” or “supercapacitor” are configured to always supply power in all weather conditions. This means that once activated, the FNOL algorithm will always be operational.

### Clauses

1. A vehicle telematics unit attached on the interior of a vehicular windscreen of a vehicle, with a corresponding mounting cradle locked to the said telematics unit, and the telematics unit released from the cradle by pressing a button on the telematics device to unlock it, the telematics push button is then locked in the downward position only when removed from its cradle, and an mechanical electrical push switch stays physically pressed by the locked press button part, causing the push button mechanical electrical switch to change its state.
2. A telematics unit according to clause 1, that is solar charged with the solar cell forming part of the telematics unit.
3. The change in state of the mechanical electrical push switch according to clause 1 is notified and sent to a remote data server
4. When the telematics unit is removed from the cradle, the original state of the calibration data before removal from the cradle is recorded as XYZ axis data, (Example1) and when the telematics units is placed back in the cradle, any discrepancy compared to the original XYZ axis data recorded is notified and sent to a remote data server
5. A method of attaching the telematics cradle as in clause 1 to the vehicular windscreen usings an adhesive gasket.
6. A method of attaching the telematics cradle as in clause 1 to the vehicular windscreen usings an adhesive pad or plurality of adhesive pads.
7. The telematics locking mechanism for the push button according to clause 1. Consisting of a plurality of non-metallic mechanical parts that interlock with each other, to allow the release of the locked telematics unit, this is due to the transmit/receive antenna inside the telematics unit is best positioned at the top of the telematics unit for good quality signal purposes and the antenna for telematic units are typically long due to the transmission frequency wave length, thus the antenna will be very near the push button mechanism parts, so only non-metallic parts are used for the mechanics of the switch locking mechanism, as metal would attenuate the radio frequency transmission and reception signal
8. In the event the telematics device is removed from its cradle via the push button, a notification is sent to a remote data server
9. In the event the telematics device is removed from its cradle via the push button, a notification is sent to a remote data server and the firmware feature in the current telematics unit will be disabled that normally records a journey.
10. In the event the telematics device is removed from its cradle via the push button, a state of change notification is sent to a remote data server and the firmware feature in the current telematics unit will be disabled that normally records a journey and recalibrates to its new XYZ axis position after a predefined time.
11. In the event the telematics device is placed back in its cradle a notification is sent to a remote data server
12. In the event the telematics device is placed back in its cradle, the push button will return to its original upright state and lock the telematics unit to the cradle and resume normal telematics operation.
13. In the event the telematics device with its cradle is removed from the vehicular windscreen, the calibration device in the telematics unit will notify the processor of this state change, this will also prompt the state of the mechanically operated mechanical electrical switch to be also notified to the processor, the state of the mechanically operated mechanical electrical switch will be reported to the remote data server in conjunction with other salient data.
14. The state of change sent as in clause 13 to the remote data server is to indicate a tamper alert
15. The gasket as claimed in clause 5, is to prevent ingress of condensation to the telematics unit.
16. A Solar charged telematics unit that is attached to a vehicle window, with deform points on the telematics frame between the frame and the windscreen that deforms in shape when a force is applied to remove the telematics device from the window.
17. A Solar charged telematics unit that is attached to a vehicle dashboard, with deform points on the telematics frame between the frame and the windscreen that deforms in shape when a force is applied to remove the telematics device from the dashboard.
18. A Solar telematics unit as claimed in clause 16, where an adhesive is used to attach the unit to the Vehicle window.
19. A Solar telematics unit as claimed in clause 17, where an adhesive is used to attach the unit to the Vehicle dashboard.
20. A telematics device fitted that causes the telematics device solar cell to open when force is used to remove the telematics device from the window.
21. A telematics device fitted that causes the telematics device solar cell to open when force is used to remove the telematics device from the dashboard.
22. A telematics device according to clauses 18, 19 or 21, that goes to tamper alert if the solar cell opens.
23. A tamper alert according to clause 22, where the data related to the tamper alert is sent via radio frequency (RF) transmission.

1. A vehicle telematics unit attachable to the interior of a dashboard or windscreen of a vehicle via a corresponding mounting cradle, wherein the mounting cradle is lockable to said telematics unit and attachable to said vehicular dashboard or windscreen,
wherein the telematics unit is releasable from the cradle by pressing a button on the telematics device to a locked down pressed state position to unlock it from the cradle, and wherein the telematics unit is configured such that pressing of the button to the locked down pressed state position causes the telematics unit to send a notification to a remote data server.

2. The telematics unit of claim 1, wherein, in the event that the telematics device is placed back in its cradle after being removed from the cradle, the telematics device is configured such that the push button returns to its original upright position to cause the telematics device to send a second notification to the remote data server.

3. The telematics unit of claim 1 further comprising a mechanical electrical push switch and an electrical circuit; wherein the telematics unit is configured such that pressing of the button to the locked down pressed state position causes the mechanical electrical push switch to change from a first state to a second state, and wherein the notification is sent by the electrical circuit and is indicative of the electrical push switch in the second state.

4. The telematics unit of claim 3, wherein, in the event that the telematics device is placed back in its cradle after being removed from the cradle, the telematics device is configured such that the push button returns to its original upright position to cause the telematics device to send a second notification to the remote data server, and wherein the electrical push switch is further configured to change from the second state to the first state upon return of the push button returns to its original upright position, and wherein the second notification is sent by the electronic circuit and is indicative of the electrical push switch in the first state.

5. The telematics unit according to claim 3, wherein the telematics unit is further configured to monitor XYZ axis data obtained from an accelerometer and/or gyroscope of the telematics device, and wherein the telematics device is further configured, upon detection of a change in the XYZ axis data, to check the state of the mechanical electrical push switch and notify the remote data server if the mechanical electrical push switch is in the first state.

6. The telematics unit according to claim 5, wherein notification to the remote data server of the mechanical electrical push switch being in the first state is indicative of tampering of the telematics unit.

7. The telematics unit according to claim 1, further comprising a calibration module configured to record an original state of the calibration data as XYZ axis data obtained from an accelerometer and/or gyroscope of the telematics device when the telematics device is locked to the cradle, and wherein the calibration module is further configured, subsequent to the relocking of the telematics device to the cradle following unlocking from the cradle via the push button, to record any discrepancy in the current XYZ axis data compared to the original XYZ axis data and to send a notification of any discrepancy to a remote data server.

8. The telematics device according to claim 7, wherein, in the event that the telematics device is placed back in its cradle after being removed from the cradle, the telematics device is configured such that the push button returns to its original upright position to cause the telematics device to send a second notification to the remote data server, and wherein the telematics unit is configured to disable the calibration module in response to a change of the mechanical electrical push switch from the first state to the second state, and wherein the telematics unit is further configured to reactivate the calibration module following a change in the mechanical electrical push switch from the second state to the first state.

9. The telematics unit according to claim 1, wherein the telematics unit is configured such that the button remains in the locked down pressed state position whilst the telematics unit is removed from the cradle.

10. The telematics unit according to claim 1 further comprising a press button part, wherein the telematics unit is configured such that pressing the button to the locked down pressed state position displaces the press button part to press the mechanical electrical switch to cause the mechanical electrical switch to change its state.

11. The telematics unit according to claim 1, wherein the telematics unit is configured such that pushing of the button to the locked down pressed position releases a pair of springs disposed in the telematics unit to displace a locking section of the telematics unit towards the cradle to push the telematics device away from the cradle to release it from the cradle.

12. The telematics unit according to claim 11, wherein the springs are part of a telematics locking mechanism of the telematics device, wherein the telematics locking mechanism consists of a plurality of non-metallic mechanical parts that interlock with each other, to allow the release of the locked telematics unit.

13. The telematics unit according to claim 1, further comprising a solar cell configured to charge a battery of the telematics unit.

14. The telematics unit according to claim 1, wherein, in the event that the telematics device is removed from its cradle via the push button, the telematics unit is further configured to disable a firmware feature in the current telematics unit that normally records a journey.

15. The telematics unit according to claim 14, wherein in the event that the telematics device is placed back in its cradle after being removed from the cradle, the telematics device is configured such that the push button returns to its original upright state to lock the telematics unit to the cradle and resume normal telematics operation.

16. A mounting cradle lockable to the telematics unit according to claim 1 and attachable to a vehicular windscreen of a vehicle.

17. The method of attaching the cradle according to claim 16 to the vehicular windscreen using an adhesive gasket.

18. The method of attaching the cradle according to claim 16 to the vehicular windscreen using an adhesive pad or plurality of adhesive pads.

19. The method according to claim 17, wherein the gasket is configured to prevent ingress of condensation to the telematics unit.

20. A system comprising the telematics unit according to claim 1 and the cradle according to claim 16.

21-27. (canceled)
